(19) United States
(12) Patent Application Publication
(10) Pub. No.: US 2020/0302707 A1
(43) Pub. Date: Sep. 24, 2020

(54) INPUT OPERATION DETECTOR

(71) Applicants: AISIN SEIKI KABUSHIKI KAISHA, Kariya-Shi (JP); HONDA MOTOR CO., LTD., Tokyo (JP)

(72) Inventors: Takanori YASUDA, Kariya-shi (JP); Takehiro TABATA, Kariya-shi (JP); Hiroshi SHINGU, Wako-shi (JP); Kenichiro KAGAWA, Wako-shi (JP); Toshihiro KANEDA, Wako-shi (JP)

(73) Assignees: AISIN SEIKI KABUSHIKI KAISHA, Kariya-shi (JP); HONDA MOTOR CO., LTD., Tokyo (JP)

(21) Appl. No.: 16/823,479

(22) Filed: Mar. 19, 2020

(30) Foreign Application Priority Data
Mar. 22, 2019 (JP) 2019-054402

(51) Int. Cl. G07C 5/08; G06F 3/01

(52) U.S. Cl. CPC G07C 5/085; G06F 3/017; G06F 3/011

(57) ABSTRACT

An input operation detector includes an operation detection electrode configured to detect an input operation from a capacitance change resulting from an approaching detection subject and a wetting detection electrode arranged next to the operation detection electrode. Water from an outer surface of a vehicle, when the vehicle is wet, collects at a location referred to as a water collection portion, and the wetting detection electrode is closer to the water collection portion than the operation detection electrode. If the water collection portion does not include water, the operation detection electrode has a greater capacitance change sensitivity than the wetting detection electrode to the approach of the detection subject. If the water collection portion includes water, the wetting detection electrode has a greater capacitance change sensitivity than the operation detection electrode to the water in the water collection portion.

### BACKGROUND

### 1. Field

The present description relates to an input operation detector.

### 2. Description of Related Art

An input operation detector includes an operation detection electrode of which capacitance changes when a detection subject, such as the hand of a user, approaches the operation detection electrode. Japanese Laid-Open Patent Publication No. 2014-122542 describes an example of such an operation detection electrode installed in a vehicle door at the inner side of a window portion, specifically, near the lower frame of the window portion. A user intuitively performs an input operation by bringing his or her hand or the like near the door, which is an operation object, to unlock the door or to open or close the door.

However, the above operation detection electrode of which capacitance changes when a detection subject approaches may react to water collected on the outer surface of the vehicle. In many cases, a window portion of a vehicle has a recess into which water collected on the outer surface of the vehicle easily flows. Thus, with the structure of the related art, if the vehicle is wet, the water collected on the outer surface of the vehicle may cause erroneous determination.

### SUMMARY

It is an objective of the present disclosure to provide an input operation detector that prevents erroneous determination and detects an input operation with good accuracy when a vehicle is in a wet state.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an input operation detector is provided. The input operation detector includes an operation detection electrode configured to detect an input operation from a capacitance change resulting from an approaching detection subject and a wetting detection electrode arranged next to the operation detection electrode. Water from an outer surface of a vehicle, when the vehicle is wet, collects at a location referred to as a water collection portion, and the wetting detection electrode is closer to the water collection portion than the operation detection electrode. If the water collection portion does not include water, the operation detection electrode has a greater capacitance change sensitivity than the wetting detection electrode to the approach of the detection subject. If the water collection portion includes water, the wetting detection electrode has a greater capacitance change sensitivity than the operation detection electrode to the water in the water collection portion.

In another general aspect, an input operation detector is provided. The input operation detector includes an operation detection electrode having a capacitance that changes when a detection subject approaches the operation detection electrode and a wetting detection electrode arranged next to the operation detection electrode. Water on an outer surface of a vehicle, when the vehicle is wet, collects at a location referred to as a water collection portion, and the wetting detection electrode has a capacitance that changes when the water collection portion includes water. The wetting detection electrode is closer to a metal component of the vehicle than the operation detection electrode and thereby has a tendency to be electrically coupled to the metal component more easily than the operation detection electrode so that if the water collection portion does not include water, a degree of change in the capacitance of the operation detection electrode when the detection subject approaches the operation detection electrode and the wetting detection electrode is greater than a degree of change in the capacitance of the wetting detection electrode when the detection subject approaches the operation detection electrode and the wetting detection electrode. The wetting detection electrode is closer to the water collection portion than the operation detection electrode so that a degree of change in the capacitance of the wetting detection electrode when the water collection portion includes water is greater than a degree of change in the capacitance of the operation detection electrode when the water collection portion includes water.

Other features and aspects will be apparent from the following detailed description, the drawings, and the claims.

### BRIEF DESCRIPTION OF THE DRAWINGS

FIG. 1 is a perspective view of a vehicle in which an input operation detector is installed.

FIG. 2 is a block diagram illustrating a schematic configuration of the input operation detector.

FIG. 3 is a perspective view of an operation detection unit of the input operation detector.

FIG. 4 is a cross-sectional view of a sliding door taken in the vicinity of a window portion where the operation detection unit is arranged.

FIG. 5 is a graph showing an example of a capacitance change caused in each operation detection electrode when an input operation is performed.

FIG. 6 is a flowchart showing a procedure for determining detection of an input operation.

FIG. 7 is a flowchart showing a procedure for determining detection of an input operation.

FIG. 8 is a diagram illustrating a state where the lower frame of a window portion includes water.

FIG. 9A is a diagram illustrating a capacitance change that occurs in an operation detection electrode and a wetting detection electrode when an input operation is performed.

FIG. 9B is a diagram illustrating a capacitance change that occurs in the operation detection electrode and the wetting detection electrode when a vehicle is wet.

FIG. 10 is a flowchart showing a procedure for performing wetting determination on the basis of a capacitance change, determination of whether an input operation has been input, and capacitance correction.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

An input operation detector 21 according to one embodiment that is installed in a sliding door 5 of a vehicle 1 will now be described with reference to the drawings.

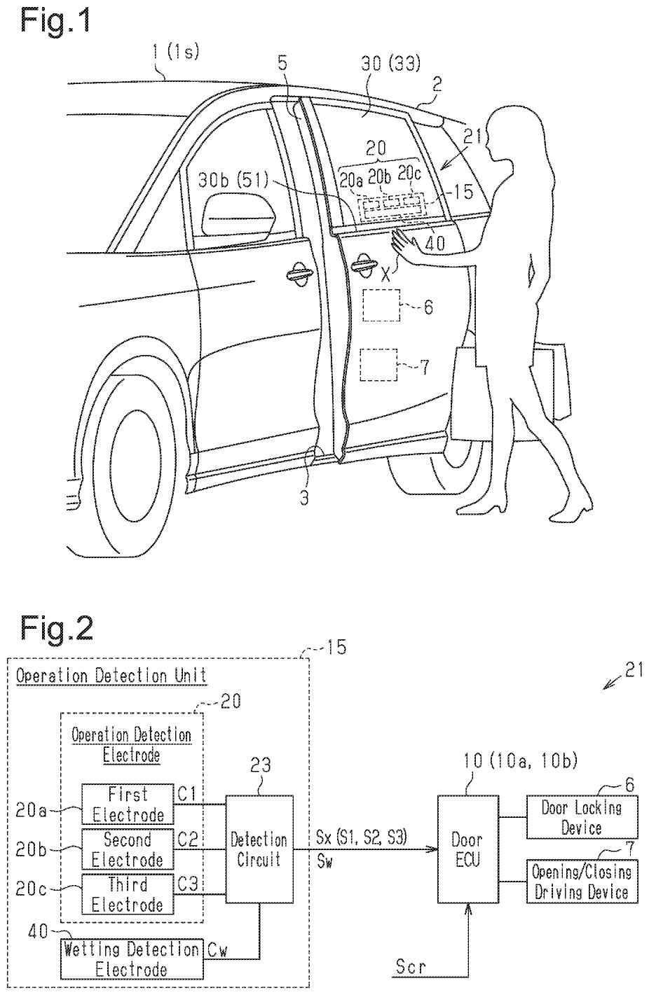

As shown in FIG. 1, the vehicle 1 according to the present embodiment includes the sliding door 5 that opens and closes a door opening 3 in one side of a vehicle body 2. The sliding door 5 of the vehicle 1 of the present embodiment has the structure of a rear door that opens toward the rear. In other words, the sliding door 5 is moved toward the rear of the vehicle (rightward in FIG. 1) to open and moved toward the front of the vehicle (leftward in FIG. 1) to close. The vehicle 1 of the present embodiment includes a door locking device 6 that drives a latch mechanism (not shown) to lock the sliding door 5 in a fully closed state and unlock the sliding door 5. The vehicle 1 also includes an opening/closing driving device 7 that uses a motor (not shown) as a drive source to open and close the sliding door 5. The vehicle 1 of the present embodiment drives the motor to open and close the sliding door 5.

Specifically, as shown in FIG. 2, the vehicle 1 of the present embodiment includes a door electronic control unit (ECU) 10 of that controls actuation of the door locking device 6 and the opening/closing driving device 7. The door ECU 10 also receives an input operation signal Scr indicating that an input operation unit arranged on, for example, the sliding door 5, a portable device (not shown), or the like held by the user, has been operated. The door ECU 10 of the present embodiment is configured to control actuation of the door locking device 6 and the opening/closing driving device 7 in response to an actuation request indicated by the input operation signal Scr.

Specifically, the door ECU 10 of the present embodiment controls the door locking device 6 upon detection of a lock request or an unlock request in the input operation signal Scr under the condition that the portable device meets electronic key security requirements. This locks the sliding door 5 in the fully closed state in accordance with the lock request and unlocks the sliding door 5 in accordance with the unlock request.

The door ECU 10 according to present embodiment also controls actuation of the opening/closing driving device 7 on condition that the sliding door 5 is in an unlocked state or shifting of the sliding door 5 to the unlocked state by actuation of the door locking device 6 is permitted. This opens the sliding door 5 in accordance with an opening actuation request indicated in the input operation signal Scr and closes the sliding door 5 in accordance with a closing actuation request.

As shown in FIGS. 1 and 2, in the vehicle 1 of the present embodiment, the sliding door 5 includes an operation detection unit 15. An output signal of the operation detection unit 15 changes when a detection subject, for example, approaches the operation detection unit 15. The detection subject may be the hand or the like of the user. Specifically, the operation detection unit 15 in the present embodiment includes three operation detection electrodes 20 of which capacitance changes when the detection subject approaches. Further, in the vehicle 1 of the present embodiment, an output signal of the operation detection unit 15 is also input to the door ECU 10. Accordingly, an input operation detector 21 that detects an input operation to the sliding door 5 in a non-contact state is configured in the vehicle 1 of the present embodiment.

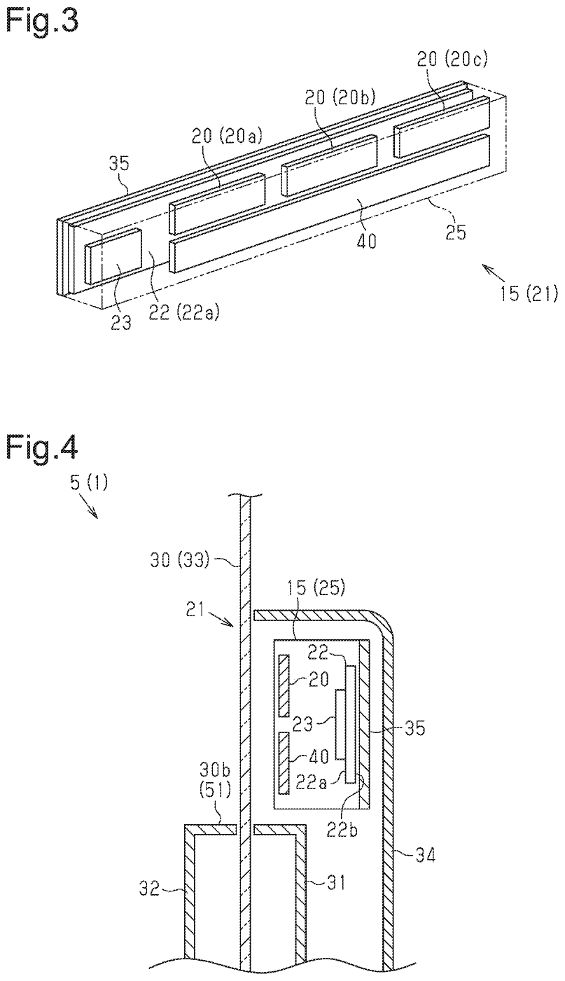

As shown in FIGS. 2 and 3, the operation detection unit 15 of the present embodiment includes the three operation detection electrodes 20. More specifically, the operation detection unit 15 of the present embodiment includes a first electrode 20a, a second electrode 20b, and a third electrode 20c. In the operation detection unit 15 of the present embodiment, the first electrode 20a, the second electrode 20b, and the third electrode 20c have substantially the same shape and the form of a substantially rectangular flat plate. The operation detection unit 15 includes a substantially rectangular board 22. The capacitance of one of the operation detection electrodes 20 will be referred to as capacitance Cx. The capacitance of the first electrode 20a, the capacitance of the second electrode 20b, and the capacitance of the third electrode 20c will respectively be referred to as capacitance C1, capacitance C2, and capacitance C3. A detection circuit 23 is mounted on the board 22 to separately detect capacitance C1, capacitance C2, and capacitance C3. In the operation detection unit 15 of the present embodiment, a substantially rectangular parallelepiped housing 25 accommodates the first electrode 20a, the second electrode 20b, and the third electrode 20c integrally with the board 22 and the detection circuit 23.

Specifically, as shown in FIG. 3, in the operation detection unit 15 of the present embodiment, the detection circuit 23 is mounted on one longitudinal end of the board 22. Further, the first electrode 20a, the second electrode 20b, and the third electrode 20c are substantially parallel to the board 22 and opposed to a mounting surface 22a of the board 22 on which the detection circuit 23 is arranged. The first electrode 20a, the second electrode 20b, and the third electrode 20c are extended and lined in the longitudinal direction of the housing 25 at positions that are not overlapped with the detection circuit 23. Accordingly, the operation detection unit 15 of the present embodiment configures three detection areas that are opposed to the mounting surface 22a of the board 22 and correspond to the first electrode 20a, the second electrode 20b, and the third electrode 20c.

More specifically, as shown in FIGS. 1 and 4, the vehicle 1 of the present embodiment includes the operation detection unit 15 installed at the inner side of a window portion 30 installed in the sliding door 5. In other words, the operation detection unit 15 is arranged in the vicinity of a lower frame 30b of the window portion 30 and extended along the lower frame 30b that extends in the front-rear direction of the vehicle. That is, the operation detection unit 15 is arranged near the lower frame 30b of the window portion 30 and extended in the direction of the opening and closing actuation of the sliding door 5. Accordingly, in the operation detection unit 15 of the present embodiment, the first electrode 20a, the second electrode 20b, and the third electrode 20c are arranged in this order from the front toward the rear of the vehicle. The operation detection unit 15 is fixed to an inner panel 31 of the sliding door 5. The operation detection unit 15 is arranged upward from the lower frame 30b of the window portion 30 so that the mounting surface 22a of the board 22, where the first electrode 20a, the second electrode 20b, and the third electrode 20c are arranged, is directed toward the outer side of the vehicle 1 (leftward in FIG. 4). Thus, the vehicle 1 of the present embodiment allows the user to view the operation detection unit 15 from the outer side of the window portion 30.

As shown in FIG. 4, in the vehicle 1 of the present embodiment, the lower frame 30b of the window portion 30 is formed by sandwiching a glass 33 between the inner panel 31 and an outer panel 32 of the sliding door 5. The operation detection unit 15 includes a surface directed toward the passenger compartment and covered by a door panel trim 34 fixed to the inner panel 31. The surface of the operation detection unit 15 directed toward the passenger compartment is directed rightward in FIG. 4. The operation detection unit 15 of the present embodiment includes a shielded electrode 35 that is covered by the door panel trim 34 and opposed to a rear surface 22b of the board 22. The shielded electrode 35 is shielded from the effect a detection subject located in the passenger compartment such as an occupant of the vehicle 1.

As shown in FIGS. 1 and 2, with the input operation detector 21 of the present embodiment, capacitance Cx of the operation detection electrode 20 included in the operation detection unit 15, specifically, capacitance C1 of the first electrode 20a, capacitance C2 of the second electrode 20b, and capacitance C3 of the third electrode 20c change when a detection subject X (such as hand) approaches the operation detection unit 15 from the outer side of the window portion 30. An operation detection signal indicating capacitance Cx of one of the operation detection electrodes 20 will be referred to as an operation detection signal Sx. An operation detection signal indicating capacitance C1 of the first electrode 20a will be referred to as a first operation signal S1. An operation detection signal indicating capacitance C2 of the second electrode 20b will be referred to as a second operation signal S2. An operation detection signal indicating capacitance C3 of the third electrode 20c will be referred to as a third operation signal S3. The operation detection unit 15 outputs the first operation signal S1, the second operation signal S2, and the third operation signal S3 to the door ECU 10. The input operation detector 21 of the present embodiment is configured so that the door ECU 10 detects an input operation to the sliding door 5 from the first operation signal S1, the second operation signal S2, and the third operation signal S3.

Specifically, the door ECU 10 of the present embodiment compares a preset threshold value Cth with capacitance C1 of the first electrode 20a indicated by the first operation signal S1, capacitance C2 of the second electrode 20b indicated by the second operation signal S2, and capacitance C3 of the third electrode 20c indicated by the third operation signal S3, all of which are input from the operation detection unit 15. Further, if capacitance Cx of the operation detection electrode 20 indicated by the operation detection signal Sx exceeds the threshold value Cth, the door ECU 10 compares the characteristics of the capacitance change with a preset input operation pattern to determine how the user performed an input operation.

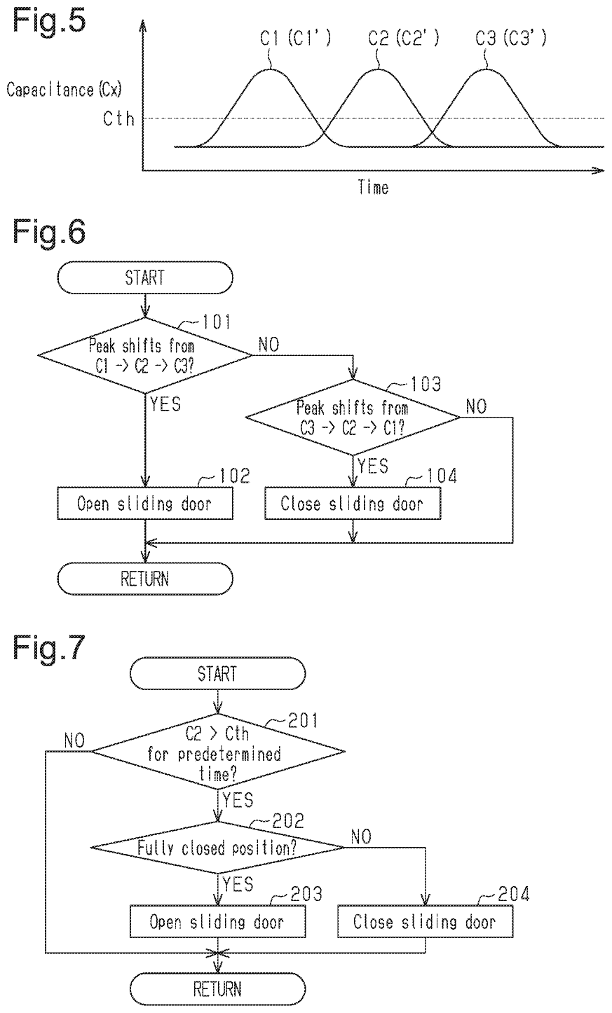

As shown in FIG. 5, if the hand brought near the operation detection unit 15 is moved from the front toward the rear of the vehicle, the peak in the capacitance change exceeding the threshold value Cth changes in the order of capacitance C1 indicated by the first operation signal S1, capacitance C2 indicated by the second operation signal S2, and capacitance C3 indicated by the third operation signal S3, namely, in the order of the first electrode 20a, the second electrode 20b, and the third electrode 20c. In other words, a peak in the capacitance change at the first electrode 20a, a peak in the capacitance change at the second electrode 20b, and a peak in the capacitance change at the third electrode 20c sequentially appear. In the input operation detector 21 of the present embodiment, such an input operation pattern in which the detection subject X is moved from the front toward the rear of the vehicle, specifically, in the opening direction of the sliding door 5 is set as an input operation requesting the sliding door 5 to open.

Specifically, as shown by the flowchart in FIG. 6, the door ECU 10 of the present embodiment determines whether a peak in a capacitance change exceeding the threshold value Cth has shifted in the order of capacitance C1 indicated by the first operation signal S1, capacitance C2 indicated by the second operation signal S2, and capacitance C3 indicated by the third operation signal S3 (step 101). If the door ECU 10 detects such characteristics in a capacitance change (step 101: YES), the door ECU 10 controls actuation of the opening/closing driving device 7 to open the sliding door 5 (step 102).

The door ECU 10 also determines whether a peak in a capacitance change exceeding the threshold value Cth has shifted in the order of capacitance C3 indicated by the third operation signal S3, capacitance C2 indicated by the second operation signal S2, and capacitance C1 indicated by the first operation signal S1 (step 103). In other words, the characteristics of such a capacitance change will be detected if the hand brought near the operation detection unit 15 is moved from the rear toward the front of the vehicle, specifically, in the closing direction of the sliding door 5. If the door ECU 10 of the present embodiment detects the characteristics of such a capacitance change (step 103: YES), the door ECU 10 controls actuation of the opening/closing driving device 7 to close the sliding door 5 (step 104).

In the input operation detector 21, a hand-holding operation in which the detection subject X, such as the hand, approaches the operation detection unit 15 from the outer side the vehicle widthwise direction is also set as an input operation pattern. In the operation detection unit 15 of the present embodiment, a longitudinally central portion where the second electrode 20b is arranged is set as an operation position where the hand-holding operation is performed. The door ECU 10 of the present embodiment is configured to open or close the sliding door 5 in accordance with the position of the sliding door 5 if the characteristics in capacitance change indicated by the operation detection signal Sx correspond to the input operation pattern of a hand-holding operation.

Specifically, as shown by the flowchart of FIG. 7, the door ECU 10 of the present embodiment determines whether capacitance C2 of the second electrode 20b indicated by the second operation signal S2 has exceeded the preset threshold value Cth for a predetermined time or longer (step 201). If capacitance C2 of the second electrode 20b indicated by the second operation signal S2 has exceeded the threshold value Cth for the predetermined time or longer (step 201: YES), that is, if the door ECU 10 detects a hand-holding operation performed by the user, the door ECU 10 determines whether the sliding door 5 is in a fully closed position (step 202). If the sliding door 5 is in the fully closed position (step 202: YES), the door ECU 10 opens the sliding door 5 (step 203). If the sliding door 5 is in any open position (step 202: NO), the door ECU 10 closes the sliding door 5 (step 204).

Wetting Detection

Wetting detection control performed by the input operation detector 21 of the present embodiment will now be described.

As shown in FIGS. 1, 3, and 4, the operation detection unit 15 of the present embodiment includes a wetting detection electrode 40 that is located downward from the first electrode 20a, the second electrode 20b, and the third electrode 20c and arranged next to the first electrode 20a, the second electrode 20b, and the third electrode 20c. The operation detection unit 15 includes the wetting detection electrode 40 arranged next to the operation detection electrode 20. The wetting detection electrode 40 of the operation detection unit 15 in the present embodiment has a substantially rectangular flat plate form extending substantially in parallel with the first electrode 20a, the second electrode 20b, and the third electrode 20c. Further, the wetting detection electrode 40 is arranged to extend under the first electrode 20a, the second electrode 20b, and the third electrode 20c. Accordingly, the wetting detection electrode 40 of the operation detection unit 15 of the present embodiment is arranged at a location that is closer to the lower frame 30b of the window portion 30 than the first electrode 20a, the second electrode 20b, and the third electrode 20c, which are arranged along the lower frame 30b of the window portion 30.

As described above, the operation detection unit 15 of the present embodiment includes the detection circuit 23 mounted on the board 22. As shown in FIG. 2, the detection circuit 23 detects capacitance Cw of the wetting detection electrode 40 separately from capacitance C1 of the first electrode 20a, capacitance C2 of the second electrode 20b, and capacitance C3 of the third electrode 20c. The operation detection unit 15 of the present embodiment outputs a wetting detection signal Sw that indicates capacitance Cw of the wetting detection electrode 40 to the door ECU 10. The door ECU 10 of the present embodiment is configured to detect that the vehicle 1 is in a wet state by comparing a capacitance change at the wetting detection electrode 40, which is indicated by the wetting detection signal Sw, with a capacitance change at the operation detection electrode 20, which is indicated by the operation detection signal Sx.

More specifically, as shown in FIGS. 1 and 4, the window portion 30 of the vehicle 1 is shaped to have a recess into which water 50 collected on an outer surface 1s of the vehicle 1 easily flows when vehicle 1 is wet. The water 50 that flows into the window portion 30 has a tendency to collect on the lower frame 30b of the window portion 30 where a belt molding is formed. In other words, the lower frame 30b of the window portion 30 is a location referred to as a water collection portion 51 where water from the outer surface 1s of the vehicle 1 collects when the vehicle 1 is wet. The operation detection electrode 20 arranged in the operation detection unit 15 may react to water 50 in the lower frame 30b of the window portion 30 serving as the water collection portion 51. This may lead to erroneous determination that a user input operation has been detected as described above.

In this regard, the input operation detector 21 of the present embodiment includes the wetting detection electrode 40, as described above, and the wetting detection electrode 40 is closer to the water collection portion 51 than the operation detection electrode 20.

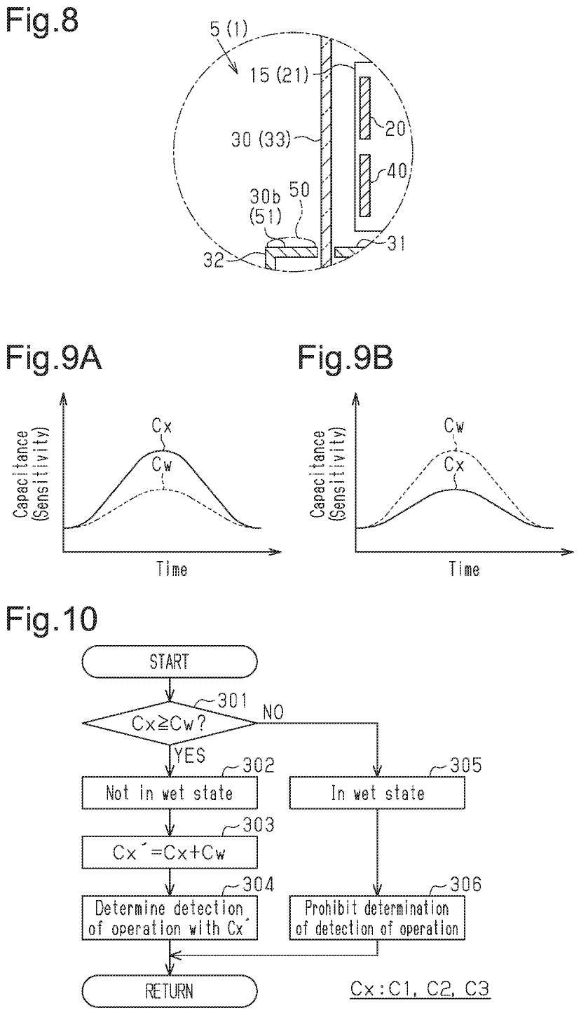

As shown in FIG. 8, if the lower frame 30b of the window portion 30 includes the water 50, the wetting detection electrode 40 arranged at a location closer to the lower frame 30b of the window portion 30 has a greater capacitance change sensitivity to the water 50 than the first electrode 20a, the second electrode 20b, and the third electrode 20c. In other words, if the water collection portion 51 includes the water 50, the wetting detection electrode 40 has a greater capacitance change sensitivity than the operation detection electrode 20 to the water 50 in the water collection portion 51. Specifically, since the wetting detection electrode 40 is closer to the water collection portion 51 than the operation detection electrode 20, a degree of change in capacitance Cw of the wetting detection electrode 40 when the water collection portion 51 includes water is greater than a degree of change in capacitance Cx of the operation detection electrode 20 when the water collection portion 51 includes water.

Specifically, as shown in FIG. 9A, the wetting detection electrode 40 of the present embodiment is configured to have a smaller capacitance than the operation detection electrode 20 (Cx>Cw) when the detection subject X (such as hand of user) approaches the operation detection electrode 20 if the lower frame 30b of the window portion 30, which serves as the water collection portion 51, does not include the water 50. Further, as shown in FIG. 9B, the wetting detection electrode 40 is also configured to have a greater capacitance than the operation detection electrode 20 (Cx<Cw) if the lower frame 30b of the window portion 30 does not include water 50. This allows the door ECU 10 of the present embodiment to detect a wet state of the vehicle 1.

FIG. 9B shows a capacitance change when the vehicle 1 is wet and water flows to the lower frame 30b of the window portion 30, which serves as the water collection portion 51 of the vehicle 1. In the vehicle 1 of the present embodiment, the wetting detection electrode 40 arranged near the lower frame 30b of the window portion 30 has a tendency to be electrically coupled to the inner panel 31 and the outer panel 32 of the sliding door 5, which are made of metal. Thus, the wetting detection electrode 40 has a smaller capacitance change sensitivity to the detection subject X such as the hand of the user that performs an input operation when the lower frame 30b does not include the water 50. In this manner, since the wetting detection electrode 40 is closer to the metal component of the vehicle 1 than the operation detection electrode 20, the wetting detection electrode 40 is more likely to be electrically coupled to the metal component than the operation detection electrode 20. If the water collection portion 51 does not include the water 50, a degree of change in capacitance Cx of the operation detection electrode 20 when the detection subject X approaches the operation detection electrode 20 and the wetting detection electrode 40 is greater than a degree of change in capacitance Cw of the wetting detection electrode 40 when the detection subject X approaches the operation detection electrode 20 and the wetting detection electrode 40. The metal component includes the inner panel 31 and the outer panel 32 of the sliding door 5.

When the operation detection electrode 20 has a greater capacitance change sensitivity than the wetting detection electrode 40, that is, when the vehicle 1 is not wet, the door ECU 10 of the present embodiment determines detection of an input operation using corrected capacitance Cx′ that is obtained by adding capacitance Cw of the wetting detection electrode 40 to capacitance Cx of the operation detection electrode 20 (Cx′=Cx+Cw).

Specifically, the door ECU 10 of the present embodiment calculates corrected value C1′ of capacitance C1 by adding capacitance Cw of the wetting detection electrode 40 to capacitance C1 of the first electrode 20a indicated by the first operation signal 51. Further, the door ECU 10 calculates corrected value C2′ of capacitance C2 by adding capacitance Cw of the wetting detection electrode 40 to capacitance C2 of the second electrode 20b indicated by the second operation signal S2. The door ECU 10 also calculates corrected value C3′ of capacitance C3 by adding capacitance Cw of the wetting detection electrode 40 to capacitance C3 of the third electrode 20c indicated by the third operation signal S3. The door ECU 10 is configured to separately compare corrected value C1′, corrected value C2′, and corrected value C3′ with the preset threshold value Cth (refer to FIG. 5) to determine detection of an input operation as described above.

More specifically, as shown by the flowchart in FIG. 10, the door ECU 10 of the present embodiment compares capacitance Cx of the operation detection electrode 20 with capacitance Cw of the wetting detection electrode 40 (step 301). If capacitance Cx of the operation detection electrode 20 is greater than or equal to capacitance Cw of the wetting detection electrode 40 (step 301: YES, Cx≥Cw), the door ECU 10 determines that the vehicle 1 is not in a wet state (step 302).

Then, the door ECU 10 performs correction calculation on capacitance Cx by adding capacitance Cw of the wetting detection electrode 40 to capacitance Cx of the operation detection electrode 20 (step 303). The door ECU 10 uses corrected capacitance Cx′ calculated in step 303 to determine detection of an input operation (step 304). The door ECU 10 corresponds to an input operation determining unit 10a.

If the door ECU 10 of the present embodiment determines that capacitance Cw of the wetting detection electrode 40 is greater than capacitance Cx of the operation detection electrode 20 (step 301: NO, Cx<Cw), the door ECU 10 determines that the vehicle 1 is in a wet state (step 305). Then, the door ECU 10 prohibits determination of detection of an input operation, which is based on a capacitance change at the operation detection electrode 20 indicated by an operation detection signal Sx (step 306). The door ECU 10 corresponds to an operation determination prohibiting unit 10b. With this structure, the input operation detector 21 of the present embodiment is configured to prevent erroneous input operation determination when the vehicle 1 is wet.

The advantages of the present embodiment will now be described.

(1) The input operation detector 21 includes the operation detection electrode 20 that detects an input operation from a capacitance change, which results from the approaching detection subject X, and the wetting detection electrode 40 arranged next to the operation detection electrode 20. The water collection portion 51 collects water 50 from the outer surface 1s of the vehicle 1 when the vehicle 1 is wet. The wetting detection electrode 40 is closer to the water collection portion 51 than the operation detection electrode 20. The input operation detector 21 is configured so that if the water collection portion 51 does not include water, the operation detection electrode 20 has a greater capacitance change sensitivity than the wetting detection electrode 40 to the approach of the detection subject X. Further, the input operation detector 21 is configured so that if the water collection portion 51 includes water, the wetting detection electrode 40 has a greater capacitance change sensitivity than the operation detection electrode 20.

With the above structure, the wet state of the vehicle 1 is detected by comparing the capacitance change sensitivity of the operation detection electrode 20 with the capacitance change sensitivity of the wetting detection electrode 40. This prevents erroneous determination and detects an input operation with high accuracy when the vehicle 1 is in a wet state.

(2) If the wetting detection electrode 40 has a greater capacitance change sensitivity than the operation detection electrode 20, the door ECU 10, which serves as the operation determination prohibiting unit 10b, prohibits determination of input operation detection, which is based on a capacitance change at the operation detection electrode 20. This prevents erroneous determination when the vehicle 1 is in a wet state.

(3) If the operation detection electrode 20 has a greater capacitance change sensitivity than the wetting detection electrode 40, the door ECU 10, which serves as the input operation determining unit 10a, determines detection of an input operation using corrected capacitance Cx′, which is obtained by adding capacitance Cw of the wetting detection electrode 40 to capacitance Cx of the operation detection electrode 20.

In other words, if the water collection portion 51 does not include the water 50, when the detection subject X approaches the operation detection electrode 20, capacitance Cw of the wetting detection electrode 40, which is arranged next to the operation detection electrode 20, is changed in the same manner as the operation detection electrode 20. Thus, an input operation is detected with improved accuracy by using corrected capacitance Cx′, which is obtained by adding capacitance Cw to capacitance Cx.

(4) The wetting detection electrode 40 is configured to have, when the detection subject X approaches the operation detection electrode 20, smaller capacitance than the operation detection electrode 20 (Cx>Cw) if the water collection portion 51 does not include the water 50. Further, the wetting detection electrode 40 is configured to have greater capacitance than the operation detection electrode 20 (Cx<Cw) if the water collection portion 51 includes the water 50.

The above structure determines detection of an input operation and determines wetting of the vehicle 1 by directly comparing capacitance Cx of the operation detection electrode 20 with capacitance Cw of the wetting detection electrode 40. This reduces the calculation load.

(5) The operation detection electrode 20 and the wetting detection electrode 40 are arranged upward from the lower frame 30b of the window portion 30 in the sliding door 5 of the vehicle 1.

With the above structure, the sliding door 5 can be operated by performing an intuitive input operation performed when the detection subject X (such as hand) is brought near the sliding door 5, which is an operation object. The water 50 that flows into the window portion 30 tends to collect on the lower frame 30b of the window portion 30 at a belt molding. Thus, the wet state of the vehicle 1 is accurately detected with by the wetting detection electrode 40 arranged upward from the lower frame 30b, which serves as the water collection portion 51.

The sliding door 5 is substantially made of metal. The wetting detection electrode 40 arranged near the lower frame 30b of the window portion 30 has a tendency to be electrically coupled to the sliding door 5, which is a conductor. Thus, the wetting detection electrode 40 can be set to have a smaller capacitance change sensitivity to the detection subject X such as the hand of the user that performs an input operation when the lower frame 30b does not include the water 50.

(6) The input operation detector 21 includes three operation detection electrodes 20 arranged along the lower frame 30b of the window portion 30. Specifically, the input operation detector 21 includes the first electrode 20a, the second electrode 20b, and the third electrode 20c arranged along the lower frame 30b of the window portion 30. The wetting detection electrode 40 is arranged to extend under the first electrode 20a, the second electrode 20b, and the third electrode 20c.

The above structure allows for the detection of plural types of input operations from a combination of a capacitance change at the first electrode 20a, a capacitance change at the second electrode 20b, and a capacitance change at the third electrode 20c. Further, the capacitance change that occurs at the first electrode 20a, the second electrode 20b, and the third electrode 20c may be separately compared with a capacitance change caused at the wetting detection electrode 40. This allows for an input operation to be detected further accurately.

The above illustrated embodiment may be modified as follows. The above-described embodiment and the following modifications can be combined as long as the combined modifications remain technically consistent with each other.

In the above embodiment, the operation detection unit 15 includes the operation detection electrode 20 and the wetting detection electrode 40 that are integrated with each other. The operation detection unit 15 is installed at the inner side of the window portion 30 in the sliding door 5 of the vehicle 1. Instead, the operation detection unit 15 may be installed at the inner side of the window portion 30 of a different type of door, such as a swing door or a back door. The operation detection unit 15 may be installed in the window portion 30 of a member other than a door that includes the lower frame 30b, which serves as the water collection portion 51. The operation detection electrode 20 and the wetting detection electrode 40 do not need to be integrated as the operation detection unit 15. The operation detection electrode 20 and the wetting detection electrode 40 may be arranged near a water collection portion 51 that differs from the lower frame 30b of the window portion 30.

In the above embodiment, the input operation detector 21 includes three operation detection electrodes 20. Specifically, the input operation detector 21 includes the first electrode 20a, the second electrode 20b, and the third electrode 20c. However, the number of the operation detection electrodes 20 may be changed. That is, the number of the operation detection electrodes 20 may be one or two. Alternatively, the input operation detector 21 may include four or more operation detection electrodes 20.

In the above embodiment, the first electrode 20a, the second electrode 20b, the third electrode 20c, and the wetting detection electrode 40 have the form of a substantially rectangular flat plate. Instead, the shapes of the operation detection electrode 20 and the wetting detection electrode 40 may be changed. The wetting detection electrode 40 does not need to extend over the entire region where the operation detection electrodes 20 are arranged.

In the above embodiment, the wetting detection electrode 40 is configured to have a smaller capacitance than the operation detection electrode 20 (Cx>Cw) when the detection subject X (such as hand of user) approaches the operation detection electrode 20 if the lower frame 30b of the window portion 30, which serves as the water collection portion 51, does not include the water 50. The wetting detection electrode 40 is also configured to have a greater capacitance than the operation detection electrode 20 (Cx<Cw) if the lower frame 30b of the window portion 30 includes the water 50.

Instead, if the water collection portion 51 does not include the water 50, the operation detection electrode 20 may have a greater capacitance change sensitivity than the wetting detection electrode 40 when the detection subject X approaches. Further, if the water collection portion 51 includes water 50, the wetting detection electrode 40 may have a greater capacitance change sensitivity than the operation detection electrode 20. In other words, capacitance Cx and capacitance Cw do not need to be directly compared. For example, capacitance Cx and capacitance Cw may each be multiplied by a unique coefficient and then compared. Alternatively, the capacitance change sensitivity may be monitored to compare the changing rate of capacitance Cx and capacitance Cw. Specifically, a degree of change in capacitance Cx of the operation detection electrode 20 may be the amount of change in capacitance Cx, the rate of capacitance Cx, a value obtained by multiplying the amount of change in capacitance Cx by a coefficient, or a value obtained by multiplying the rate of capacitance Cx by a coefficient. Likewise, a degree of change in capacitance Cw of the wetting detection electrode 40 may be the amount of change in capacitance Cw, the rate of capacitance Cw, a value obtained by multiplying the amount of change in capacitance Cw by a coefficient, or a value obtained by multiplying the rate of capacitance Cw by a coefficient. Correction calculation performed by adding capacitance Cw of the wetting detection electrode 40 to capacitance Cx of the operation detection electrode 20 may be changed. Specifically, a value obtained by multiplying capacitance Cw of the wetting detection electrode 40 by a unique coefficient may be added to a value obtained by multiplying capacitance Cx of the operation detection electrode 20 by a unique coefficient.

The above embodiment prohibits determination of detection of an input operation, which is based on a capacitance change at the operation detection electrode 20 if the wetting detection electrode 40 has a greater capacitance change sensitivity than the operation detection electrode 20. Instead, the determination condition to determine detection of an input operation may be stricter if the wetting detection electrode 40 has a greater capacitance change sensitivity than the operation detection electrode 20, specifically, if the vehicle 1 is in a wet state. Specifically, the input operation detector 21 may include, for example, a determination condition changing unit that varies the threshold value to limit determination of an input operation. This configuration also prevents erroneous determination in a preferred manner if the vehicle 1 is in a wet state.

In the above embodiment, an input operation performed by the user is detected if peaks in a capacitance change exceeding the threshold value Cth at the first electrode 20a, the second electrode 20b, and the third electrode 20c shift in the direction of the opening and closing actuation of the sliding door 5 and if capacitance C2 of the second electrode 20b exceeds the threshold value Cth for the predetermined time or longer. Instead, an input operation by the user may be detected through an input operation pattern other than a “swipe operation” and a “hand-holding operation.”

The door ECU 10 (specifically, input operation determining unit 10a and operation determination prohibiting unit 10b) is not limited to a device that includes a CPU and a ROM and executes software processing. For example, a dedicated hardware circuit (such as ASIC) may be provided that executes at least part of the software processes executed in the above-described embodiment. That is, the door ECU 10 may be modified to have any one of the following configurations (a) to (c). (a) A configuration including a processor that executes all of the above-described processes according to programs and a program storage device such as a ROM that stores the programs. (b) A configuration including a processor and a program storage device that execute part of the above-described processes according to the programs and a dedicated hardware circuit that executes the remaining processes. (c) A configuration including a dedicated hardware circuit that executes all of the above-described processes. A plurality of software executing devices each including a processor and a program storage device and a plurality of dedicated hardware circuits may be provided. That is, the above processes may be executed by processing circuitry that includes at least one of a set of one or more software executing devices or a set of one or more dedicated hardware circuits. The program storage device, or computer readable media, includes any type of media that are accessible by general-purpose computers and dedicated computers.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An input operation detector comprising:
an operation detection electrode configured to detect an input operation from a capacitance change resulting from an approaching detection subject; and
a wetting detection electrode arranged next to the operation detection electrode, wherein water from an outer surface of a vehicle, when the vehicle is wet, collects at a location referred to as a water collection portion, and the wetting detection electrode is closer to the water collection portion than the operation detection electrode, wherein
if the water collection portion does not include water, the operation detection electrode has a greater capacitance change sensitivity than the wetting detection electrode to the approach of the detection subject, and
if the water collection portion includes water, the wetting detection electrode has a greater capacitance change sensitivity than the operation detection electrode to the water in the water collection portion.

2. The input operation detector according to claim 1, comprising an operation determination prohibiting unit configured to prohibit determination of detection of the input operation from the capacitance change when the wetting detection electrode has a greater capacitance change sensitivity than the operation detection electrode.

3. The input operation detector according to claim 1, comprising an input operation determining unit configured to determine detection of the input operation using a corrected capacitance obtained by adding a capacitance of the wetting detection electrode to a capacitance of the operation detection electrode when the operation detection electrode has a greater capacitance change sensitivity than the wetting detection electrode.

4. The input operation detector according to claim 1, wherein
the wetting detection electrode is configured to have a smaller capacitance than the operation detection electrode if the detection subject approaches when the water collection portion does not include water, and
the wetting detection electrode is configured to have a greater capacitance than the operation detection electrode when the water collection portion includes water.

5. The input operation detector according to claim 1, wherein
the water collection portion is configured by a lower frame of a window portion in a door of the vehicle, and
the operation detection electrode and the wetting detection electrode are arranged upward from the lower frame.

6. The input operation detector according to claim 5, wherein
the operation detection electrode is one of a plurality of operation detection electrodes arranged along the lower frame, and
the wetting detection electrode is arranged to extend under the operation detection electrodes.

7. An input operation detector comprising:
an operation detection electrode having a capacitance that changes when a detection subject approaches the operation detection electrode; and
a wetting detection electrode arranged next to the operation detection electrode, wherein water on an outer surface of a vehicle, when the vehicle is wet, collects at a location referred to as a water collection portion, and the wetting detection electrode has a capacitance that changes when the water collection portion includes water, wherein
the wetting detection electrode is closer to a metal component of the vehicle than the operation detection electrode and thereby has a tendency to be electrically coupled to the metal component more easily than the operation detection electrode so that if the water collection portion does not include water, a degree of change in the capacitance of the operation detection electrode when the detection subject approaches the operation detection electrode and the wetting detection electrode is greater than a degree of change in the capacitance of the wetting detection electrode when the detection subject approaches the operation detection electrode and the wetting detection electrode, and
the wetting detection electrode is closer to the water collection portion than the operation detection electrode so that a degree of change in the capacitance of the wetting detection electrode when the water collection portion includes water is greater than a degree of change in the capacitance of the operation detection electrode when the water collection portion includes water.

8. The input operation detector according to claim 7, wherein
the water collection portion is configured by a lower frame of a window portion in a door of the vehicle, and
the operation detection electrode and the wetting detection electrode are arranged upward from the lower frame.

9. The input operation detector according to claim 7, wherein the metal component includes an inner panel and an outer panel of a door of the vehicle.
